(19) United States
(12) Patent Application Publication
(10) Pub. No.: US 2026/0186824 A1
(43) Pub. Date: Jul. 2, 2026

(54) TASK PROCESSING METHOD AND ELECTRONIC DEVICE

(71) Applicant: Lenovo (Beijing) Limited, Beijing (CN)

(72) Inventor: Xiangyu MU, Beijing (CN)

(21) Appl. No.: 19/425,518

(22) Filed: Dec. 18, 2025

(30) Foreign Application Priority Data
Dec. 31, 2024 (CN) 202411999757.6

(51) Int. Cl. G06F 9/48

(52) U.S. Cl. CPC G06F 9/4837; G06F 9/4856

(57) ABSTRACT

A task processing method includes obtaining, in response to receiving at least one task request, a remaining duration for a first processing model to enter an idle state, in response to the remaining duration meeting a target condition, loading and executing at least one second processing model based on the first processing model, and processing the at least one task request using the at least one second processing model. The first processing model is in a first execution space, and the at least one second processing model is in a second execution space different from the first execution space.

### CROSS-REFERENCE TO RELATED APPLICATION

This application claims priority to Chinese Patent Application No. 202411999757.6, filed on December 31, 2024, the entire content of which is incorporated herein by reference.

### TECHNICAL FIELD

The present disclosure generally relates to the field of model processing technologies and, more particularly, to a task processing method and an electronic device.

### BACKGROUND

With the advancement of large language model (LLM) deployment on personal computers (PCs), the number of applications using LLM is increasing, leading to the emergence of multiple tasks accessing the same model concurrently. However, when multiple tasks access the same model concurrently, the model’s memory mechanism may cause confusion in question-and-answer.

### SUMMARY

In accordance with the disclosure, there is provided a task processing method including obtaining, in response to receiving at least one task request, a remaining duration for a first processing model to enter an idle state, in response to the remaining duration meeting a target condition, loading and executing at least one second processing model based on the first processing model, and processing the at least one task request using the at least one second processing model. The first processing model is in a first execution space, and the at least one second processing model is in a second execution space different from the first execution space.

Also in accordance with the disclosure, there is provided an electronic device including a processor, and a memory storing instructions that, when executed by the processor, cause the electronic device to obtain, in response to receiving at least one task request, a remaining duration for a first processing model to enter an idle state, in response to the remaining duration meeting a target condition, load and execute at least one second processing model based on the first processing model, and process the at least one task request using the at least one second processing model. The first processing model is in a first execution space, and the at least one second processing model is in a second execution space different from the first execution space.

Also in accordance with the disclosure, there is provided a non-transitory computer-readable storage medium storing instructions that, when executed by a processor, cause an electronic device including the processor to obtain, in response to receiving at least one task request, a remaining duration for a first processing model to enter an idle state, in response to the remaining duration meeting a target condition, load and execute at least one second processing model based on the first processing model, and process the at least one task request using the at least one second processing model. The first processing model is in a first execution space, and the at least one second processing model is in a second execution space different from the first execution space.

### BRIEF DESCRIPTION OF THE DRAWINGS

FIG. 1 is a flow chart of a task processing method consistent with embodiments of the present disclosure.

FIG. 2 is a flow chart of another task processing method consistent with embodiments of the present disclosure.

FIG. 3 is a flow chart of another task processing method consistent with embodiments of the present disclosure.

FIG. 4 is a flow chart of another task processing method consistent with embodiments of the present disclosure.

FIG. 5 is a flow chart of another task processing method consistent with embodiments of the present disclosure.

FIG. 6 is a schematic block diagram showing task processing consistent with embodiments of the present disclosure.

FIG. 7 is a schematic structural diagram of a task processing apparatus consistent with embodiments of the present disclosure.

FIG. 8 is a schematic structural diagram of an electronic device consistent with embodiments of the present disclosure.

### DETAILED DESCRIPTION OF THE EMBODIMENTS

Various schemes and features of the present disclosure are described herein with reference to the accompanying drawings. The terms used in the present disclosure are only used to explain the specific embodiments of the present disclosure and are not intended to limit the scope of the present disclosure. It is understandable to those skilled in the art that with the development of technology and the emergence of new scenarios, the technical solutions provided in the embodiments of the present disclosure are also applicable to similar technical problems.

Unless otherwise defined, all technical and scientific terms used in the present disclosure have the same meaning as those generally understood by those skilled in the art. The terms used in the present disclosure are only for the purpose of description and are not intended to limit the scope of the present disclosure.

The terms including “some embodiments,” “this embodiment,” “one embodiment,” etc., indicate a subset of all possible embodiments, but it can be understood that “some embodiments” may be the same subset or different subsets of all possible embodiments, and may be combined with each other without conflict.

The terms “first/second/third” involved in the present disclosure are only used to distinguish similar objects, and do not represent a specific order for the objects. It is understood that objects described by “first/second/third” can be interchanged with a specific order or sequence where permitted, such that the embodiments of the present disclosure described here can be implemented in an order other than that illustrated or described here.

The terms “including,” “comprising,” or “having,” and any variations thereof, are intended to cover a non-exclusive inclusion, such that a process, method, system, product, or apparatus that comprises a list of elements is not necessarily limited to those elements but may include other elements not expressly listed or inherent to such process, method, product, or device. The term “and/or” is merely a description of the association relationship between associated objects, indicating that three possible relationships may exist. For example, object A and/or object B can represent three situations: object A exists alone, object A and object B exist at the same time, and object B exists alone.

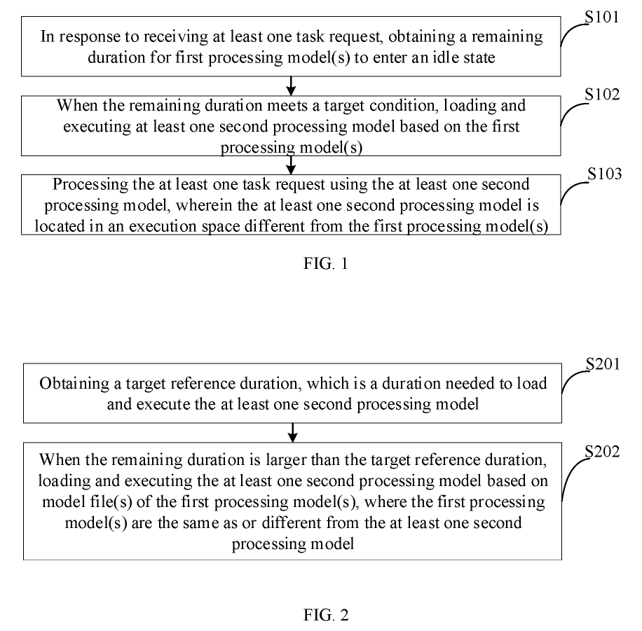

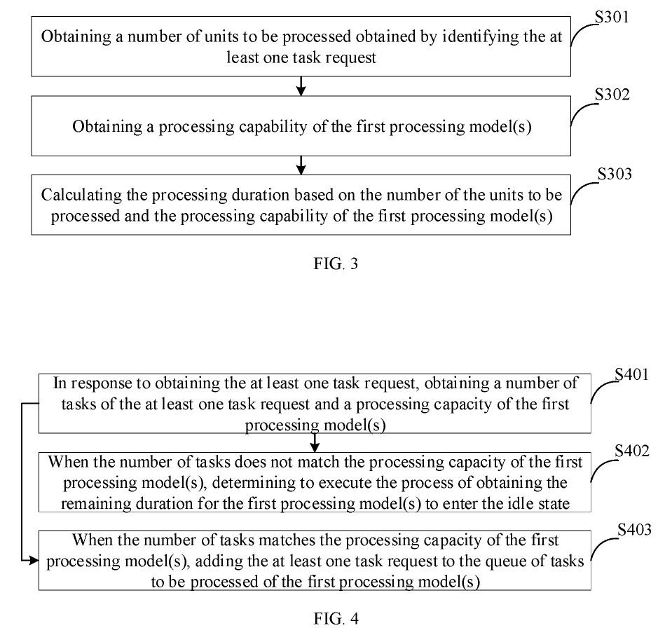

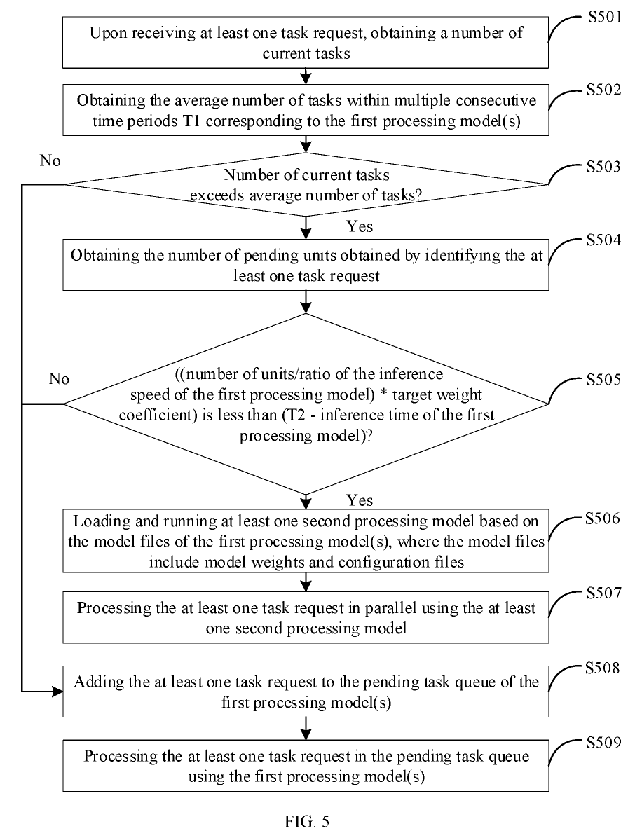

The present disclosure provides a task processing method. As shown in FIG. 1, which is a flowchart of the task processing method consistent with the present disclosure, the method may be applied to an electronic device, including but not limited to smartphones, tablets, or desktop computers. As shown in FIG. 1, the task processing method includes S101 to S103.

At S101, in response to receiving at least one task request, a remaining duration for first processing model(s) to enter an idle state is obtained.

For example, in one embodiment, upon receiving the at least one task request, the elapsed inference duration of the first processing model(s) and the average processing duration of the first processing model(s) for the current number of historical task requests may be obtained. Based on the difference between the average processing duration and the elapsed inference duration, the remaining time needed for the first processing model(s) to complete the current task (i.e., to enter the idle state) may be obtained. A first processing model may be a large language Model (LLM), which is used to handle various text processing tasks such as text generation, translation, summarization, question-and-answering, as well as image processing tasks or other processing tasks.

When no task is currently being executed, the remaining duration for the first processing model(s) to enter the idle state may be zero. A task request may be a call request from at least one different application for the same model, or it may be multiple call requests from the same user or different users for the same application. Exemplary task requests may include, but are not limited to, requests for text generation or processing, image generation or processing, video generation or processing, or audio processing or processing.

At S102, when the remaining duration meets a target condition, at least one second processing model is loaded and executed based on the first processing model(s).

In this embodiment, whether the remaining duration for the first processing model(s) to enter the idle state meets the target condition may be determined. When the remaining duration meets the target condition, at least one virtual model or backup model (i.e., the second processing model) may be initialized and started based on the first processing model. When the remaining duration does not meet the target condition, the at least one task request may be added to the pending task queue of the first processing model(s), and the first processing model(s) may be used to process the at least one task request in the pending task queue serially or in parallel. The choice of serial or parallel processing may depend on the number of the first processing model(s). When there is only one first processing model, the at least one task request in the pending task queue may be processed serially using the first processing model. When there are multiple first processing models, the multiple first processing models may be used to process the at least one task request in the pending task queue in parallel.

The target condition may be used to determine whether to load and execute the at least one second processing model based on the first processing model.

One second processing model may be identical to the first processing model, or it may be only a partial model of the first processing model, i.e., a processing model created based on some operators and model weight configuration files of the first processing model.

In one embodiment, the number of the at least one second processing model may depend on the number of tasks in the task request, i.e., the number of the at least one second processing model may be the same as the number of tasks in the task request. Alternatively, in another embodiment, the number of the at least one second processing model may be less than the number of the tasks in the task request. This is because some task requests have a contextual relationship, i.e., the at least one second processing model may process the at least one task request with a contextual relationship serially.

At S103, the task request is processed using the at least one second processing model, where the at least one second processing model is located in a different execution space than the first processing model(s).

In this embodiment of the present disclosure, the at least one task request in the batch may be processed using the at least one second processing model, while currently executing tasks may be processed using the first processing model(s). Therefore, the first processing model(s) and the at least one second processing model may process different task requests in parallel.

In one embodiment, the at least one second processing model and the first processing model(s) may be located in different execution spaces, achieving operational isolation between the first processing model(s) and the at least one second processing model, which further isolates tasks processed by the first processing model(s) from those processed by the at least one second processing model, thereby resolving question-and-answer confusion or response confusion caused by the memory mechanism during multi-tasking.

In some embodiments of the present disclosure, when the remaining duration meets the target condition, loading and running the at least one second processing model based on the first processing model(s) may include S201 and S202.

At S201, a target reference duration, which is the duration needed to load and run the at least one second processing model, is obtained.

In this embodiment of the present disclosure, the target reference duration may be understood as the total duration needed to independently launch the at least one second processing model.

For example, in one embodiment, there may be a correspondence between the number of the at least one second processing model to be launched and the reference duration. Therefore, the target reference duration may be determined based on the number of the at least one second processing model to be loaded and launched. That is, the target reference duration may be a fixed duration. Alternatively, in some other embodiments, the target reference duration may be dynamically determined based on the task to be executed. In some other embodiments, alternatively, the target reference duration may be dynamically determined based on the computing resource configuration of the electronic device.

At S202, when the remaining duration exceeds the target reference duration, the at least one second processing model is loaded and executed based on model file(s) of the first processing model(s), where the first processing model(s) and the at least second processing model may be the same or different.

It should be noted that, when the remaining duration for the first processing model to enter the idle state is longer than the target reference duration needed to load and run the at least one second processing model, it may not be necessary to wait for the first processing model(s) to complete its tasks. Instead, it may be necessary to load and run the at least one second processing model based on the model files of the first processing model(s). The at least one second processing model may then be used to process the at least one task request, thereby rapidly processing the at least one task request.

In one embodiment, the at least one second processing model may be identical to the first processing model(s), meaning that the model weights and configuration files of the at least one second processing model are exactly the same as those of the first processing model(s). Alternatively, in some other embodiments, the at least one second processing model may be different from the first processing model(s), meaning that a portion of the model weights and configuration files of the second processing models are identical to those of the first processing model(s), while the remaining portions are different. These different parts may correspond to different computing or operation capabilities.

In some embodiments, obtaining the target reference duration may include at least one of:

obtaining the processing duration needed for the first processing model(s) to process the at least one task request and processing the processing duration based on target weight coefficients to obtain the target reference duration;

obtaining task information of the at least one task request, determining configuration information of the at least one second processing model based on the task information, and determining the target reference duration based on the configuration information;

reading the target reference duration from a preset configuration file; or

determining the target reference duration based on configuration data or usage data of a processor of the electronic device.

In one embodiment, assuming that the first processing model(s) are used to process the at least one task request, the total processing duration needed for the first processing model(s) to complete the at least one task request may be calculated. Further, the total processing duration needed to complete the at least one task request may be multiplied by the target weight coefficient to obtain the total duration needed to load and run the at least one second processing model, i.e., the target reference duration. The target weight coefficient may be a preset value that may be set by a developer based on experience or experimentation.

Alternatively, assuming that the at least one task request is processed by the first processing model(s), the processing duration needed by the first processing model(s) to complete each task request may be calculated. A weighted sum may be taken based on the processing duration needed for each task request and its corresponding target weight coefficient to obtain the total duration needed to load and run the at least one second processing model, i.e., the target reference duration. The target weight coefficients corresponding to different task requests or second processing models may or may not be the same.

In another embodiment, the task information of the at least one task request may be obtained and the configuration information of the at least one second processing model may be determined based on the task information, to determine the target reference duration based on the configuration information. The task information may include, but is not limited to, task content, task complexity, or the length of instruction or information input to the at least one second processing model, including the task request. The configuration information may include, but is not limited to, configuration parameters or the complexity of the configuration parameters. The configuration parameters may include configuration files or model weights.

Exemplarily, the configuration parameters of the at least one second processing model may be determined based on the task content of the at least one task request, and the target reference duration needed to load and run the at least one second processing model may be determined based on the configuration parameters of the at least one second processing model. Alternatively, based on the task complexity of the at least one task request, the complexity of the configuration parameters of the at least one second processing model may be determined, and based on the complexity of the configuration parameters of the at least one second processing model, the target reference duration needed to load and run the at least one second processing model may be determined, where a higher complexity of the configuration parameters may correspond to a longer target reference duration.

In another embodiment, the target reference duration may be read from the pre-set configuration file. Exemplarily, the pre-set configuration file may include a configuration table of models and reference durations for processing different tasks. The reference duration corresponding to one second processing model may be retrieved from the configuration table, and the at least one reference duration may be summed to obtain the target reference duration. Alternatively, the pre-set configuration file may include a configuration table of processing model size and reference duration, where the processing model size may be determined by the model weight and the configuration file. The reference duration corresponding to the size of one second processing model may be retrieved from the configuration table, and the at least one reference duration may be summed to obtain the target reference duration.

In another embodiment, the target reference duration may be determined based on the configuration data or the usage data of the processor of the electronic device. For example, there may be a relationship equation with the configuration data and usage data of the electronic device’s processor as independent variables and the target reference duration as the dependent variable. By substituting the configuration data and usage data of the electronic device’s processor into the relationship equation, the corresponding target reference duration may be obtained.

In some embodiments, obtaining the processing duration needed by the first processing model(s) to process the at least one task request may include S301 to S303.

At S301, the number of pending units obtained by identifying the at least one task request is determined.

In this embodiment, identification processing (e.g., word segmentation) may be performed on the at least one task request to obtain multiple pending units, i.e., multiple tokens, thereby determining the number of the multiple pending units, i.e., the number of tokens.

At S302, the processing capability of the first processing model(s) is obtained.

In this embodiment, the processing capability of a first processing model may include the model’s inference speed, which may include, but is not limited to, the inference speed when executing a previous task request or the average inference speed when executing multiple task requests over a period.

At S303, the processing duration is calculated based on the number and the processing capability of the first processing model(s).

In this embodiment, the ratio of the number of pending units corresponding to the at least one task request to the processing capability of the first processing model(s) may be calculated to obtain the processing duration needed by the first processing model(s) to process the at least one task request. Exemplarily, the ratio of the number of pending units corresponding to at least one task request to the inference speed of the first processing model(s) may be calculated to obtain the processing duration needed by the first processing model(s) to process the at least one task request.

In some embodiments, obtaining the remaining duration for the first processing model to enter the idle state may include S401 to S403.

At S401, in response to obtaining the at least one task request, the number of tasks in the at least one task request and the processing capacity of the first processing model(s) are obtained.

In one embodiment, the number of tasks for the at least one task request within a duration T1 may be counted. The processing capacity of the first processing model(s) may include, but is not limited to, the number of tasks within the previous duration T1 or the average number of tasks within multiple consecutive duration T1s.

After S401, whether the number of tasks matches the processing capacity of the first processing model(s) may be determined. When the number of tasks does not match the processing capacity of the first processing model(s), S402 may be executed. When the number of tasks matches the processing capacity of the first processing model(s), S403 may be executed.

At S402, when the number of tasks does not match the processing capacity of the first processing model, it is determined to execute the process of obtaining the remaining duration for the first processing model(s) to enter the idle state.

Exemplarily, when the number of tasks exceeds the average number of tasks within a plurality of consecutive duration periods T corresponding to the first processing model(s), it may be determined that the processing capacity of the first processing model(s) is not matched, i.e., the current state is a high-concurrency task state. Furthermore, obtaining the remaining duration until the first processing model(s) enter the idle state may be executed.

At S403, when the number of tasks matches the processing capacity of the first processing model(s), the at least one task request is added to the pending task queue of the first processing model(s).

Exemplarily, when the number of tasks does not exceed the average number of tasks within a plurality of consecutive duration periods T corresponding to the first processing model(s), it may be determined that the processing capacity of the first processing model(s) is matched, i.e., the current state is not a high-concurrency task state. Therefore, the at least one task request may be added to the pending task queue of the first processing model(s), and the pending tasks in the pending task queue may be subsequently processed serially or in parallel using the first processing model(s).

In some embodiments of the present disclosure, loading and running the at least one second processing model based on the first processing model(s) may include at least one of the following.

The task information for the at least one task request may be obtained, and the model weights and configuration files matching the task information may be determined from the model files of the first processing model(s). Then the at least one second processing model may be initialized using the model weights and configuration files in a second execution space different from the first execution space where the first processing model(s) reside.

In this embodiment, the task information may include, but is not limited to, task content, configuration requirements of the task processing model, or task processing specification requirements. Based on this, the model weights and configuration files corresponding to the task content may be matched from the model files of the first processing model(s), and the at least one second processing model may be initialized using the model weights and configuration files in the second execution space different from the first execution space where the first processing model(s) reside. Alternatively, the model weights and configuration files corresponding to the configuration requirements of the task processing model may be matched from the model file of the first processing model, and the at least one second processing model may be initialized using the model weights and configuration files in the second execution space different from the first execution space where the first processing model(s) reside. Alternatively, the model weights and configuration files corresponding to the task processing specification requirements may be matched from the model files of the first processing model(s), and the at least one second processing model may be initialized using the model weights and configuration files in the second execution space different from the first execution space where the first processing model(s) reside.

The first execution space may be understood as the working storage space of the first processing model(s). The second execution space may be understood as the working storage space for the at least one second processing model.

When there are multiple task requests, the number of tasks in the at least one task request may be obtained, and the model files of the first processing model(s) are loaded into multiple execution spaces corresponding to the number of tasks, thereby initializing multiple second processing models in parallel within the multiple execution spaces.

In this embodiment, the number of execution spaces for the at least one second processing model depends on the number of tasks in the task request. For example, when the number of tasks in the at least one task request is six, the model files of the first processing model(s) may be loaded into the corresponding six execution spaces, thereby initializing six second processing models in parallel within the six execution spaces.

The model files of the first processing model(s) may mirror model files of the first processing model(s), or partial model files that match the respective task request, determined based on the respective task information.

When there are multiple task requests, the association relationship between the multiple task requests may be obtained, and based on the association relationship, the model files of the first processing model(s) may be loaded into at least one execution space different from the execution space where the first processing model(s) reside, thereby initializing the at least one second processing model.

In this embodiment, the association relationship between multiple task requests may be used to determine whether the tasks require a necessary top-down relationship or serial processing. When some tasks require serial processing, there may be no need to create a corresponding number of second processing models; that is, the number of second processing models is less than the number of tasks.

For example, when task request 1 and task request 5 have a top-down relationship, and task request 2 and task request 3 have a top-down relationship, the model files of the first processing model(s) may be loaded into four different execution spaces from the first processing model(s), and four second processing models may be initialized. The second processing model 1 then may process task requests 1 and 5 serially, the second processing model 2 may process task requests 2 and 3 serially, and the remaining two second processing models 3 and 4 may process task requests 4 and 6, respectively. Various second processing models may process tasks in parallel.

In some embodiments of the present disclosure, the method may further include at least one of:

when the remaining duration is not longer than the target reference duration, adding the at least one task request to the pending task queue of the first processing model(s);

when there are multiple task requests, using multiple second processing models to process the multiple task requests in parallel; or

when there is a single task request, using the second processing model to process the unique task request while the current tasks are being processed using the first processing model(s).

In one embodiment, when the remaining duration is not longer than the target reference duration, the at least one task request may be added to the pending task queue of the first processing model(s). When the remaining duration for the first processing model(s) to enter the idle state is not longer than the target reference duration needed to load and run the second processing model, there may be no need to create the second processing model based on the first processing model(s). Instead, the at least one task request may be added to the pending task queue of the first processing model(s), and the first processing model(s) may wait for the first processing model(s) to complete the task execution. Subsequently, the first processing model(s) may process the pending tasks serially or in parallel based on the identification information of the pending tasks in the pending task queue.

In one embodiment, when there are multiple task requests, multiple second processing models may be used to process the multiple task requests in parallel.

For example, there may be six task requests, including task request 1, task request 2, task request 3, task request 4, task request 5, and task request 6. Task request 1 may be processed using second processing model 1. Simultaneously, task request 2 may be processed in parallel using second processing model 2, task request 3 may be processed in parallel using second processing model 3, task request 4 may be processed in parallel using second processing model 4, task request 5 may be processed in parallel using second processing model 5, and task request 6 may be processed in parallel using second processing model 6. In other words, the six task requests may be processed in parallel using six second processing models.

In one embodiment, when there is a single task request, the second processing model may be used to process the unique task request in parallel while the first processing model(s) are used to process the current tasks.

For example, when there is a single task request 1, the first processing model(s) may be used to process the current tasks while the second processing model may be used to process task request 1 in parallel. In other words, the first and second processing models may process different task requests in parallel.

In some embodiments of the present disclosure, obtaining the at least one task request may include at least one of:

obtaining multiple task configuration operations of multiple applications on the electronic device, thereby obtaining multiple task requests, where each of the multiple applications is able to invoke the first processing model(s) to execute the task requests;

obtaining multiple task requests inputted to a first application on the electronic device, where each of the multiple task requests needs to invoke the first processing model(s) to execute corresponding processing actions; or

receiving multiple task requests from multiple terminals via a communication connection with the electronic device, where the electronic device is a device configured with the first processing model(s) and capable of executing the task requests.

In one embodiment, the multiple task configuration operations of multiple applications on the electronic device may be obtained, thereby obtaining the multiple task requests. Each of the multiple applications may be able to invoke the first processing model(s) to execute the task requests.

The multiple task configuration operations for the multiple applications on the electronic device may be same or similar task requests posted by a user on different applications. Therefore, the electronic device may obtain the posted task requests. For example, a user may post a task for image creation on Lenovo’s Creator Zone or Xiaotian; therefore, an image creation task request from Lenovo’s Creator Zone or Xiaotian may be obtained. Alternatively, a user may post a task for text creation or document processing on Lenovo’s Learning Zone and Xiaotian simultaneously, therefore a task request for text creation or document processing from Lenovo’s Learning Zone and Xiaotian may be obtained.

In one embodiment, the multiple task requests inputted to the first application on the electronic device may be obtained. Each of the multiple task requests may need to invoke the first processing model(s) to execute corresponding processing actions.

The user may input the multiple task requests into the first application, thereby obtaining the multiple task requests from the first application.

In one embodiment, the multiple task requests may be received from the multiple terminals via the communication connection with the electronic device. The electronic device may be a device configured with the first processing model(s) and capable of executing the task requests.

The multiple terminals may be separately connected to the electronic device, and the same user or different users may input task requests into applications on the multiple terminals. The multiple terminals may then transmit their respective received task requests to the electronic device, thereby receiving the multiple task requests from the multiple terminals.

Exemplarily, in a home scenario, terminal devices of different users may send task requests to a home center device (such as an AI Center) to enable non-AI devices to use AI device functional services.

In some embodiments of the present disclosure, the method may further include at least one of:

in response to the electronic device configured with the first processing model(s) establishing a communication connection with a first processing device, transmitting at least one of the at least one task request to the first processing device for processing; or

when the electronic device is equipped with a third processing model, assigning at least one of the at least one task request to the third processing model for processing.

In one embodiment, in response to the electronic device configured with the first processing model(s) establishing the communication connection with the first processing device, at least one of the at least one task request may be transmitted to the first processing device for processing.

The first processing device may be an AI device in an edge network (such as a laptop, chassis, all-in-one (AIO) computer, or AI computing card), or a server providing AI services in the cloud.

Exemplarily, the electronic device configured with the first processing model(s) may establish a communication connection with the AIO. When the remaining duration for the first processing model(s) to enter the idle state meets a target condition, at least one second processing model may be loaded and executed based on the first processing model(s). When the number of second processing models is less than the number of task requests, some of the task requests may be processed in parallel using the at least one second processing model, and the electronic device may send the remaining task requests to the AIO for processing by the AIO.

In one embodiment, when the electronic device is equipped with the third processing model, at least one of the at least one task request may be assigned to the third processing model for processing.

The electronic device may be equipped with not only the first processing model(s) but also a third processing model. The third processing model may have the same function as the first processing model(s). There may be at least one third processing model.

Based on this, when the remaining duration for the first processing model(s) to enter the idle state meets a target condition, at least one second processing model may be loaded and executed based on the first processing model(s). When the number of second processing models is less than the number of task requests, some of the task requests may be processed in parallel using the at least one second processing model, and the remaining task requests may be processed using the third processing model.

In another embodiment shown in FIG. 5, which is a flowchart of a task processing method consistent with the present disclosure, the method includes:

S501: upon receiving at least one task request, obtaining a number of current tasks;

S502: obtaining the average number of tasks within multiple consecutive time periods T1 corresponding to the first processing model(s);

S503: determining whether the number of current tasks exceeds the average number of tasks, if so, executing S504; and if not, executing S508, where the number of current tasks exceeding the average number of tasks indicates that the current state is a high-concurrency task state and the number of tasks not exceeding the average number of tasks indicates that the current state is not a high-concurrency task state;

S504: obtaining the number of pending units obtained by identifying the at least one task request;

S505: determining whether a product of a target weight coefficient and a ratio of the number of pending units to the inference speed of the first processing model is less than a difference between T2 and the inference time of the first processing model; if so, executing S506; and if not, executing S508, where the product of the target weight coefficient and the ratio of the number of pending units to the inference speed of the first processing model is the target reference duration, and T2 minus the inference time of the first processing model is the remaining duration for the first processing model(s) to enter the idle state. T2 can be the average processing time of the first processing model for the current number of historical task requests;

S506: loading and running at least one second processing model based on the model files of the first processing model(s), where the model files include model weights and configuration files.

S507: processing the at least one task request in parallel using the at least one second processing model;

S508: adding the at least one task request to the pending task queue of the first processing model(s); and

S509: processing the at least one task request in the pending task queue using the first processing model(s).

For example, the at least one task request in the pending task queue may be processed serially or in parallel using the first processing model(s). The choice of serial or parallel processing may depend on the number of current first processing model(s). When there is only one first processing model, the at least one task request in the pending task queue may be processed serially using the first processing model. When there are multiple first processing models, multiple first processing models may be used to process the at least one task request in the pending task queue in parallel.

The second processing model and the first processing model(s) may be located in different execution spaces, achieving operational isolation between the first and second processing models. Furthermore, tasks processed by the first processing model(s) and those processed by the second processing model may be isolated, thus resolving the issue of question- answer or response confusion caused by the memory mechanism during multi-task concurrency. Also, for high-concurrency tasks, task isolation may be implemented, allowing the application to seamlessly switch to multi-model inference. There may be no need for specific internal inference optimizations for different models, such as adjusting the KVCache, layering, or operators. For scenarios with low concurrency requirements, hierarchical scheduling may support concurrency by caching tasks through task queues without sacrificing inference speed. Based on the above embodiments, this application illustrates a task processing block diagram.

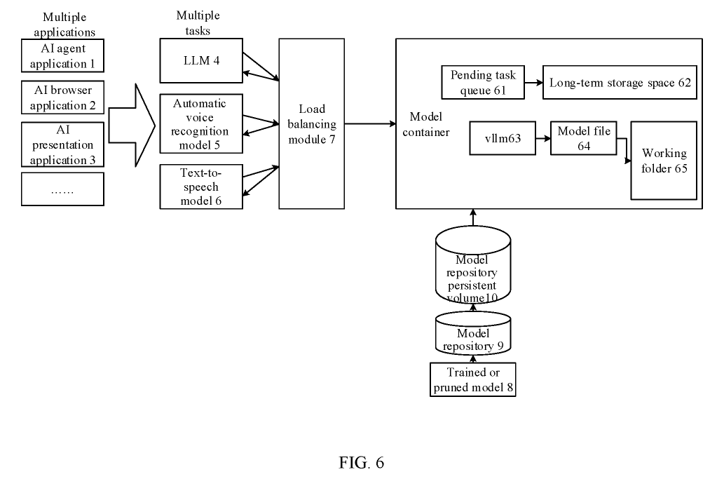

FIG. 6 is a task processing block diagram consistent with the present disclosure. As shown in FIG. 6, in one embodiment, there are multiple applications, including but not limited to AI agent application 1, AI browser application 2, and AI presentation application 3.

The load balancing module may be used to execute the task processing method provided by the present disclosure, that is, to receive a request from each application to invoke the first processing model(s), where one first processing model may be an LLM model 4, an automatic speech recognition (ASR) model 5, or a text-to-speech (TTS) model 6.

In response to the at least one task request, the load balancing module 7 may obtain the remaining duration for the first processing model(s) to enter the idle state based on the number of tasks in the task request and the average number of tasks within a continuous period T1 corresponding to the first processing model(s) when determining the current high-concurrency task state. When the remaining duration is longer than the time needed to load and run the second processing model, the load balancing module may allocate at least one working storage space, i.e., a running space. The load balancing module 7 may obtain partial or complete model weights and configuration files, i.e., model files 64 (stored in a working folder 65), corresponding to each task request based on the first processing model(s) using the virtual machine model (VLLM) 63 architecture. The load balancing module may then load and run the at least one second processing model in the at least one working storage space, and use the at least one second processing model to process the at least one task request in parallel. When the current state is determined to be not a high-concurrency task state based on the number of task requests and the average number of tasks corresponding to the first processing model(s) within a continuous time period T1, or when the remaining duration is no longer than the time needed to load and run the second processing model, a container orchestration tool may be used to allocate a long-term storage space 62 for storing the pending task queue 61 of the first processing model(s). At least one task request may be added to the pending task queue of the first processing model(s), pending serial or parallel processing of the at least one task request by the first processing model(s).

Trained or pruned models may need to be stored in a model repository for subsequent deployment, testing, or sharing. The model repository may provide unified model management, allowing users to easily find and use trained or pruned models. The model repository may rely on persistent volumes to ensure the long-term preservation and reliability of model data. Persistent volumes may provide a high-performance, highly available, and scalable storage solution for the model repository, helping to improve the overall performance and user experience of the model repository.

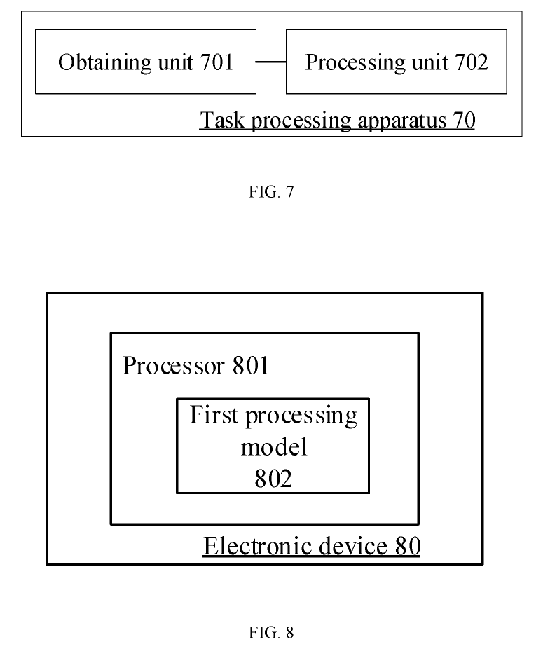

The present disclosure also provides a task processing apparatus. In one embodiment shown in FIG. 7, which is a schematic structural diagram of the task processing apparatus consistent with the present disclosure, the task processing apparatus 70 includes:

an obtaining unit 701, configured to obtain, in response to obtaining at least one task request, a remaining duration for first processing model(s) to enter an idle state; and

a processing unit 702, configured to load and execute at least one second processing model based on the first processing model(s) when the remaining duration meets a target condition.

The processing unit 702 may be further configured to process the at least one task request using the at least one second processing model.

The at least one second processing model may be located in an execution space different from the first processing model(s).

In the present disclosure, the second processing model and the first processing model(s) may be located in different execution spaces, thereby achieving operational isolation between the first and second processing models. Furthermore, task isolation between tasks processed by the first processing model(s) and those processed by the second processing model may be also achieved, thereby resolving the issue of question-answer or response confusion caused by the memory mechanism during multi-tasking.

In some embodiments of the present disclosure, the processing unit 702 may be further configured to: obtain a target reference duration. The target reference duration may be a duration needed to load and run the at least one second processing model; and I, when the remaining duration is longer than the target reference duration, load and run the at least one second processing model based on the model files of the first processing model(s), where the first processing model(s) are the same as or different from the at least one second processing model.

In some embodiments of the present disclosure, the processing unit 702 may be further configured to perform at least one of: obtaining the processing duration needed for the first processing model(s) to process the at least one task request and processing the processing duration based on a target weight coefficient to obtain the target reference duration; obtaining task information for the at least one task request, determining configuration information for the at least one second processing model based on the task information, and determining the target reference duration based on the configuration information; reading the target reference duration from a pre-configured configuration file; or determining the target reference duration based on configuration data and usage data of a processor of the electronic device.

In some embodiments of the present disclosure, the processing unit 702 may be further configured to: obtain a number of pending units obtained by identifying the at least one task request; obtain the processing capacity of the first processing model(s); and calculate the processing duration based on the number of the pending units and the processing capacity of the first processing model(s).

In some embodiments of the present disclosure, the processing unit 702 may be further configured to perform: in response to obtaining the at least one task request, obtaining the number of tasks in the task request and the processing capacity of the first processing model(s); when the first task state is determined based on the number of tasks and the processing capacity of the first processing model(s), executing the step of obtaining the remaining duration for the first processing model(s) to enter the idle state; when the second task state is determined based on the number of tasks and the processing capacity of the first processing model(s), adding the at least one task request to the to-be-processed task queue of the first processing model(s).

In some embodiments of the present disclosure, the processing unit 702 may be further configured to perform at least one of:

obtaining task information for the at least one task request, determining a model weight and a configuration file matching the task information from the model files of the first processing model(s), and initializing the at least one second processing model in a second execution space different from the first execution space where the first processing model(s) reside using the model weight and configuration file;

when there are multiple task requests, obtaining the number of task requests, loading the model files of the first processing model(s) into multiple execution spaces whose number corresponds to the number of task requests, and concurrently initializing multiple second processing models in the multiple execution spaces;

when there are multiple task requests, obtaining associations between the multiple task requests, and based on the associations, loading the model files of the first processing model(s) into at least one execution space different from the first processing model(s), and initializing the at least one second processing model.

In some embodiments of the present disclosure, the processing unit 702 may be further configured to: when the remaining duration is not longer than the target reference duration, add the at least one task request to the pending task queue of the first processing model; when there are multiple task requests, process the multiple task requests in parallel using multiple second processing models; and when there is a single task request, process the unique task request in parallel using the second processing model while processing the current tasks using the first processing model(s).

In some embodiments of the present disclosure, the obtaining unit 701 may be configured to perform at least one of:

obtaining multiple task configuration operations for multiple applications on an electronic device, thereby obtaining multiple task requests, each of which is capable of invoking the first processing model(s) to execute the task requests;

obtaining multiple task requests input to a first application on the electronic device, each of which needs to invoke the first processing model(s) to execute the corresponding processing actions; or

obtaining multiple task requests sent from multiple terminals via a communication connection with an electronic device, where the electronic device is configured with the first processing model(s) and is capable of executing the task requests.

In some embodiments of the present disclosure, the processing unit 702 may be further configured to perform at least one of:

in response to the electronic device configured with the first processing model(s) establishing a communication connection with a first processing device, transmitting at least one of the at least one task request to the first processing device for processing; or

when the electronic device is configured with a third processing model, transmitting at least one of the at least one task request to the third processing model for processing.

The present disclosure also provides an electronic device. In one embodiment shown in FIG. 8, which is a schematic structural diagram of an electronic device consistent with the present disclosure, the electronic device 80 includes: a processor 801 and at least one first processing model 802 capable of running on the processor. The first processing model 802 may be stored in a memory of the electronic device and called by a target application to perform at least one of:

obtaining, in response to obtaining at least one task request, a remaining duration for first processing model(s) to enter an idle state;

loading and running at least one second processing model based on the first processing model(s) when the remaining duration meets a target condition; or

processing the at least one task request using the at least one second processing model.

The at least one second processing model may be located in an execution space different from the first processing model(s).

The processor may be at least one of an application-specific integrated circuit (ASIC), a digital signal processing device (DSPD), a programmable logic device (PLD), a field-programmable gate array (FPGA), a controller, a microcontroller, or a microprocessor. It is understood that the electronic components used to implement the processor functions may be other components for different devices, and the embodiments of the present disclosure do not specifically limit this.

The memory may be a volatile memory, such as a random-access memory (RAM); or a non-volatile memory, such as a read-only memory (ROM), a flash memory, a hard disk drive (HDD), or a solid-state drive (SSD); or a combination of these types of memory, and may be configured to provide instructions and data to the processor.

The present disclosure also provides a computer-readable storage medium for storing a computer program.

Optionally, the computer-readable storage medium may be applied to any of the methods in the embodiments of the present disclosure, and the computer program may be configured to cause a computer to execute the corresponding processes implemented by the processor in each of the methods in the embodiments of the present disclosure. For the sake of brevity, this description is omitted here.

The present disclosure also provides a computer program product including a computer program, which may be executed by a processor of an electronic device to make the electronic device perform the task processing methods provided by any embodiments of the present disclosure.

It should be understood that the disclosed devices and methods can be implemented in other ways. The device embodiments described above are merely illustrative. For example, the division of units described is merely a logical functional division. In actual implementation, other divisions may be used, such as combining multiple units or components, integrating them into another system, or omitting or not implementing certain features. Furthermore, coupling, connection, or communication connection between the components shown or discussed may be indirect coupling or communication connection between devices or units through interfaces, and may be electrical, mechanical, or other forms.

The units described above as separate components may or may not be physically separate. The components shown as units may or may not be physical units, that is, they may be located in one location or distributed across multiple network units. Some or all of these units may be selected to achieve the objectives of the present disclosure according to actual needs.

The functional units in the various embodiments of the present disclosure may all be integrated into a single processing module, each unit may be independently configured as a unit, or two or more units may be integrated into a single unit. The integrated units may be implemented in hardware or as hardware plus software functional units. Those integrated units can be implemented in the form of hardware or in the form of hardware plus software functional units. Those skilled in the art will understand that all or part of the steps of the above-mentioned method embodiment may be implemented by hardware related to program instructions. The aforementioned program can be stored in a computer-readable storage medium. When the program is executed, the above-mentioned method embodiments may be implemented. The aforementioned storage medium includes various media that can store program code, such as mobile storage devices, read-only memory (ROM), random access memory (RAM), magnetic disks or optical disks.

The features disclosed in the present disclosure may be combined in any way, unless they conflict with each other, to produce new product embodiments.

The features disclosed in the method or device embodiments provided in the present disclosure can be combined in any way, unless they conflict with each other, to produce new method or device embodiments.

The above describes in detail a plurality of embodiments of the present disclosure, but the present disclosure is not limited to these specific embodiments. Those skilled in the art can make various variations and modifications based on the concept of the present disclosure, and these variations and modifications shall fall within the scope of the present disclosure.

What is claimed is:

1. A task processing method comprising:
obtaining, in response to receiving at least one task request, a remaining duration for a first processing model to enter an idle state;
in response to the remaining duration meeting a target condition, loading and executing at least one second processing model based on the first processing model; and
processing the at least one task request using the at least one second processing model;
wherein the first processing model is in a first execution space, and the at least one second processing model is in a second execution space different from the first execution space.

2. The method according to claim 1, wherein, in response to the remaining duration meeting the target condition, loading and executing the at least one second processing model based on the first processing model includes:
obtaining a target reference duration for loading and executing the at least one second processing model; and
in response to the remaining duration being longer than the target reference duration, loading and executing the at least one second processing model based on a model file of the first processing model, the first processing model being same as or different from the at least one second processing model.

3. The method according to claim 2, wherein obtaining the target reference duration includes:
obtaining a processing duration needed by the first processing model to process the at least one task request and processing the processing duration based on a target weight coefficient to obtain the target reference duration.

4. The method according to claim 3, wherein obtaining the processing duration includes:
obtaining a number of pending units obtained by identifying the at least one task request;
obtaining a processing capability of the first processing model; and
calculating the processing duration based on the number and the processing capability.

5. The method according to claim 2, wherein obtaining the target reference duration includes:
obtaining task information of the at least one task request;
determining configuration information of the at least one second processing model based on the task information; and
determining the target reference duration based on the configuration information.

6. The method according to claim 2, wherein obtaining the target reference duration includes:
reading the target reference duration from a pre-configured configuration file.

7. The method according to claim 2, wherein obtaining the target reference duration includes:
determining the target reference duration based on configuration data or usage data of a processor of an electronic device.

8. The method according to claim 2, further comprising at least one of:
in response to the remaining duration being not longer than the target reference duration, adding the at least one task request to a pending task queue of the first processing model;
in response to the at least one task request including a plurality of task requests, processing the plurality of task requests in parallel using a plurality of second processing models; or
in response to the at least one task has only one task request, processing the only one task request using the at least one second processing model while a current task is being processed using the first processing model.

9. The method according to claim 1, wherein obtaining the remaining duration includes:
in response to obtaining the at least one task request, obtaining a number of tasks of the at least one task request and a processing capacity of the first processing model;
in response to the number not matching the processing capacity, obtaining the remaining duration; and
in response to the number matching the processing capacity, adding the at least one task request to a pending task queue of the first processing model.

10. The method according to claim 1, wherein loading and executing the at least one second processing model includes at least one of:
obtaining task information of the at least one task request, determining a model weight and a configuration file that match the task information from a model file of the first processing model, and using the model weights and configuration files to initializing the at least one second processing model in the second execution space;
in response to the at least one task request including a plurality of task requests and the at least one second processing model includes a plurality of second processing models:
obtaining a number of tasks of the plurality of task requests;
loading a model file of the first processing model into a plurality of execution spaces corresponding to the number of tasks; and
initializing the plurality of second processing models in parallel in the plurality of execution spaces; or
in response to the at least one task request including a plurality of task requests and the at least one second processing model includes a plurality of second processing models:
obtaining an association relationship between the plurality of task requests; and
loading a model file of the first processing model into at least one execution space different from the first execution space based on the association relationship, and initializing the at least one second processing model.

11. The method according to claim 1, wherein obtaining the at least one task request includes at least one of:
obtaining a plurality of task configuration operations for a plurality of applications on an electronic device, and obtaining a plurality of task requests, each of the plurality of applications is capable of invoking the first processing model to execute the task requests;
obtaining a plurality of task requests input to an application on an electronic device, each of the plurality of task requests needing to invoke the first processing model to execute a corresponding processing action; or
obtaining a plurality of task requests each sent from one of a plurality of terminals via a communication connection with an electronic device that is configured with the first processing model and is capable of executing the task requests.

12. The method according to claim 1, further comprising at least one of:
in response to an electronic device configured with the first processing model establishing a communication connection with a processing device, transmitting at least one of the at least one task request to the processing device for processing; or
in response to the electronic device being configured with a third processing model, allocating at least one of the at least one task request to the third processing model for processing.

13. An electronic device comprising:
a processor; and
one or more memories storing instructions and a first processing model, the instructions, when executed by the processor, causing the electronic device to:
obtain, in response to receiving at least one task request, a remaining duration for the first processing model to enter an idle state;
in response to the remaining duration meeting a target condition, load and execute at least one second processing model based on the first processing model; and
process the at least one task request using the at least one second processing model;
wherein the first processing model is in a first execution space, and the at least one second processing model is in a second execution space different from the first execution space.

14. The electronic device according to claim 13, wherein the instructions, when executed by the processor, further cause the electronic device to, when in response to the remaining duration meeting the target condition, loading and executing the at least one second processing model based on the first processing model:
obtain a target reference duration for loading and executing the at least one second processing model; and
in response to the remaining duration being longer than the target reference duration, load and execute the at least one second processing model based on a model file of the first processing model, the first processing model being same as or different from the at least one second processing model.

15. The electronic device according to claim 14, wherein the instructions, when executed by the processor, further cause the electronic device to, when obtaining the target reference duration:
obtain a processing duration needed by the first processing model to process the at least one task request and processing the processing duration based on a target weight coefficient to obtain the target reference duration.

16. The electronic device according to claim 15, wherein the instructions, when executed by the processor, further cause the electronic device to, when obtaining the processing duration:
obtain a number of pending units obtained by identifying the at least one task request;
obtain a processing capability of the first processing model; and
calculate the processing duration based on the number and the processing capability.

17. The electronic device according to claim 14, wherein the instructions, when executed by the processor, further cause the electronic device to, when obtaining the target reference duration:
obtain task information of the at least one task request;
determine configuration information of the at least one second processing model based on the task information; and
determine the target reference duration based on the configuration information.

18. The electronic device according to claim 14, wherein the instructions, when executed by the processor, further cause the electronic device to, when obtaining the target reference duration:
read the target reference duration from a pre-configured configuration file.

19. The electronic device according to claim 14, wherein the instructions, when executed by the processor, further cause the electronic device to, when obtaining the target reference duration:
determine the target reference duration based on configuration data or usage data of a processor of an electronic device.

20. A non-transitory computer-readable storage medium storing instructions that, when executed by a processor, cause an electronic device including the processor to:
obtain, in response to receiving at least one task request, a remaining duration for a first processing model to enter an idle state;
in response to the remaining duration meeting a target condition, load and execute at least one second processing model based on the first processing model; and
process the at least one task request using the at least one second processing model;
wherein the first processing model is in a first execution space, and the at least one second processing model is in a second execution space different from the first execution space.
